(19) United States
(12) Patent Application Publication
(10) Pub. No.: US 2008/0046184 A1
(43) Pub. Date: Feb. 21, 2008

(54) Method for estimating forest inventory

(76) Inventors: Zachary Bortolot, Morehead, KY (US); John Paul McTague, Suwanee, GA (US)

Correspondence Address: J. WILEY HORTON, ESQUIRE;Pennington, Moore, Wilkinson, Bell & Dunbar, P.A., (215 S. Monroe Street, 2d Floor, 32301), Post Office Box 10095, Tallahassee, FL, 32302-2095, US

(21) Appl. No.: 11/505,189

(22) Filed: Aug. 16, 2006

(51) Int. Cl. G06F 19/00; G06F 17/40; G06F 17/11

(52) U.S. Cl. 702/2; 702/187; 702/1; 703/6; 702/127; 702/179; 382/100; 382/110

(57) ABSTRACT

A method of using remotely sensed data and ground measurements to accurately estimate forest inventories. The proposed method includes two complimentary components—an image processing component and a post processing component. The image processing component predicts a forest parameter of interest for one or more forest stands using the remotely sensed data. The post processing component further processes the output from the image processing component to quantify results that are in a form that is more useful to end users.

### BACKGROUND OF THE INVENTION

1. Field of the Invention

This invention relates to the field of timber cruising and forest sampling. More specifically the present invention comprises a method of using remotely sensed data and ground measurements to accurately estimate forest inventories.

2. Description of the Related Art

The ability to accurately assess forest inventories is important in various forestry management programs. As an example, in order to maximize timber harvested during forestry operations, it is helpful to know the species composition of the forest, tree size, and density. In some cases, it is also helpful to track a forest inventory over time to see how the forest responds to various environmental conditions.

Timber cruising generally involves collecting information about the composition of the forest including the number of each tree species present, size and age of each tree or stand, density or crowding of the trees, and canopy coverage. Because measuring attributes of every tree in a forest is impractical, timber cruising generally involves the use of sampling methods. Sampling generally involves collecting data at certain areas throughout the forest. Data collected at the sampled sites is used to predict inventory data for the entire forest.

There are many disadvantages associated with conventional timber cruising methods. Conventional timber cruising methods do not always yield sufficiently accurate results. The effectiveness of any sampling method is influenced by the number of sample sites used in a designated area and whether tree attributes are distributed uniformly throughout the forest. Because many forests do not have uniform characteristics, it is often necessary to take numerous samples. This excessive sampling requirement often becomes time consuming and labor intensive.

Accordingly, it would be beneficial to provide a method for estimating forest inventories which yields accurate attribute assessments without the need for a large sample size of ground measurements.

### BRIEF SUMMARY OF THE INVENTION

The present invention comprises a method of using remotely sensed data and ground measurements to accurately estimate forest inventories. The proposed method includes two complimentary components—an image processing component and a post processing component. The image processing component predicts forest parameters of interest for one or more forest stands using the remotely sensed data. The post processing component further processes the output from the image processing component to quantify results that are in a form that is more useful to end users.

The method includes establishing ground plots at different geographic locations within a forest. Forest attributes are then measured for each of the ground plots by a person on the ground. Remotely sensed data is also obtained for the geographic regions corresponding to the various ground plots. The remotely sensed data may include various types of digital imagery including passive optical imagery and small footprint light distance and ranging (LiDAR) data. Remotely sensed data is preprocessed, mathematically transforming the data for analysis. If passive optical imagery is used, the remotely sensed data may be transformed to produce a vegetation index image. For LiDAR data, the data is rasterized as an array of pixels in a grid, and canopy height models (CHMs) may be produced. Thresholds are then applied to the grid of preprocessed data to produce sets of metrics which describe the remotely sensed data. For each threshold that is applied, a corresponding set of metrics is obtained. The metrics may include percentage of pixels of the grid which exceed the threshold (such as a minimum canopy height), percentage of pixels of the grid which represent core pixels, and average value of pixels in the grid which exceed the threshold.

Each set of metrics is then correlated to the forest attributes measured from the ground. Mathematical expressions are developed for each set of metrics and a score is computed for each mathematical expression which describes how accurately the mathematical expression relates the set of metrics to the ground-measured data. The scores are compared and the optimal mathematical expression is determined.

The optimal mathematical expressions and corresponding optimal thresholds are then used to estimate forest attributes of interest for the remainder of the forest stand. In order to estimate forest attributes for other portions of a forest stand, remotely sensed data for other portions of a forest stand is first obtained. The remotely sensed data is again preprocessed to produce a grid of values corresponding to the remotely sensed data. The optimal threshold values are applied to the grid of values to compute sets of metrics. The sets of metrics may then be inserted into the optimal equations to compute an estimate of a particular forest parameter of interest.

A post processing component is used to convert the outputs from the image processing component into a form that is more useful to the end user. In the preferred embodiment, a stock and stand table is computed for the forest stand. The stock and stand table reports volume per acre, basal area per acre, and trees per acre. These values are provided for each 1-inch diameter class, species group, and product for the forest stand.

### BRIEF DESCRIPTION OF THE SEVERAL VIEWS OF THE DRAWINGS

FIG. 1 is a flowchart, illustrating the present invention.

FIG. 2 is an array of pixels, illustrating a canopy height model.

FIG. 3A is an array of pixels, illustrating a first threshold applied to a canopy height model.

FIG. 3B is an array of pixels, illustrating core pixels of a thresholded canopy height model.

FIG. 4A is an array of pixels, illustrating a second threshold applied to a canopy height model.

FIG. 4B is an array of pixels, illustrating core pixels of a thresholded canopy height model.

FIG. 5 is a flowchart, illustrating the post-processing component of the present invention.

### REFERENCE NUMERALS IN THE DRAWINGS

| | | | |
|---|---|---|---|
| 10 | step | 12 | step |
| 14 | step | 16 | initial thresholds |
| 18 | remotely sensed data | 20 | measured data |
| 22 | step | 24 | step |
| 26 | step | 28 | step |
| 30 | determination | 32 | step |
| 34 | step | 36 | step |
| 38 | post processing | 40 | grid |
| 42 | pixels | 44 | non-shaded region |
| 46 | shaded region | 48 | non-shaded region |
| 50 | step | 52 | measured data |
| 54 | measured data | 56 | measured data |
| 58 | measured data | 60 | step |
| 62 | model data | 64 | model data |
| 66 | model data | 68 | remotely sensed data |
| 70 | step | 72 | step |
| 74 | output | | |

### DETAILED DESCRIPTION OF THE INVENTION

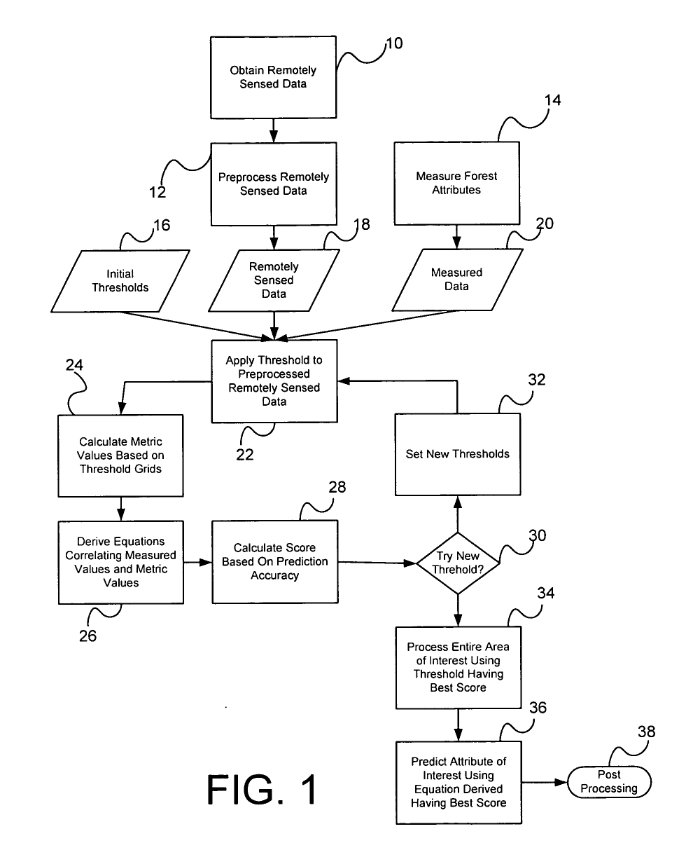

A flowchart illustration of a method for estimating forest inventory is provided in FIG. 1. Ground plots are initially established at different geographic locations within a forest. As indicated by step 14, forest attributes are then measured for each of the ground plots. There are many types of forest attributes that may be measured by a person on the ground. Several common measurements, or parameters of interest, include the number of trees in an acre, the biomass or volume of the trees in the acre, and the basal area in an acre. The term basal area, as used herein, describes the cross-sectional area of a tree at four and a half feet above the ground. Various methods are known and used for measuring or computing these values.

As indicated by step 10, remotely sensed data is also obtained for the geographic regions corresponding to the various ground plots. The term “remotely sensed data” as used herein generally describes data about the earth obtained from an airplane, satellite, or other platform that is higher than the earth's surface. The remotely sensed data may include various types of digital imagery such as passive optical imagery and small footprint light distance and ranging (LiDAR) data. “Passive optical imagery” involves capturing images that are based on the reflectance of solar energy in the visible, near-infrared and/or shortwave infrared portion of the light spectrum. Small footprint LiDAR data is generally collected by emitting pulses of laser light from an airborne or spaceborne platform, and then measuring the amount of time it takes for the pulse to return to the platform and the intensity of the returns. The term “small footprint” indicates that a relatively narrow laser beam (typically less than 50 cm in diameter measured at the height of the canopy) is used.

Remotely sensed data is preprocessed, as indicated by step 12, mathematically transforming the data for analysis. During preprocessing, LiDAR data is rasterized as an array of pixels in a grid. If passive optical imagery is used, the remotely sensed data may be transformed to produce a vegetation index image. A vegetation index image is an image in which the numerical values associated with each pixel have been mathematically transformed to produce an array of pixels in which each pixel corresponds to the density and health of the vegetation in the corresponding area on the ground. Multiple techniques are commonly used and known for calculating vegetation indices using passive optical imagery. For LiDAR data, canopy height models (CHMs) may be produced. A canopy height model is a grid of pixels produced from small footprint LiDAR data where each pixel is assigned a value corresponding to the height of the canopy at that location.

Most modern LiDAR instruments return five or more measurements per reading. These measurements typically include a “distance” measurement for the top of the canopy, the ground, and several intermediate measurements which indicate the height of branches or leaves. It should be noted that the intermediate measurements may also be incorporated to produce models that are even more sophisticated than CHMs. For simplicity, however, the following description will focus on CHMs.

Initial thresholds 16 are then applied to the grid of preprocessed data and sets of metrics are calculated which describe the remotely sensed data, as indicated by step 22. For each threshold that is applied, a corresponding set of metrics is obtained. The metrics may include percentage of pixels of the grid which exceed the threshold, percentage of the pixel grid which represent core pixels, and average value of pixels in the grid which exceed the threshold.

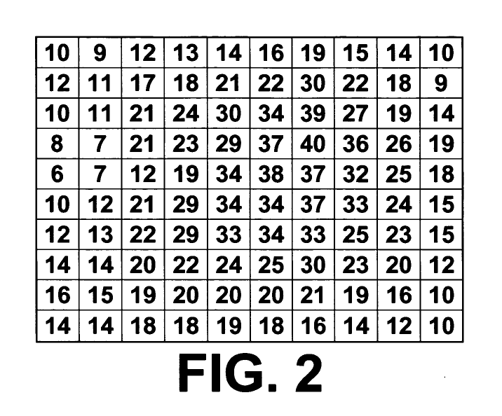

An example of remotely sensed data presented as an array of pixels is illustrated in FIG. 2. FIG. 2 represents canopy height model data for a portion of a ground plot. Grid 40 includes ten columns and ten rows (or one-hundred total) pixels 42. Each pixel 42 represents an area of the ground. For example, each pixel 42 may represent a 1 meter by 1 meter square of the ground. Contiguous pixels represent contiguous areas of the ground. The numerical value of each pixel 42 represents the relative height of the canopy at a geographic location. Although the numerical value may be the actual height of the tree's canopy from the ground (expressed as a unit of length), the value may also describe the height of the tree's canopy relative to another reference point. Accordingly, the value of each pixel 42 directly or indirectly describes the height of the canopy at the geographic location represented by the pixel.

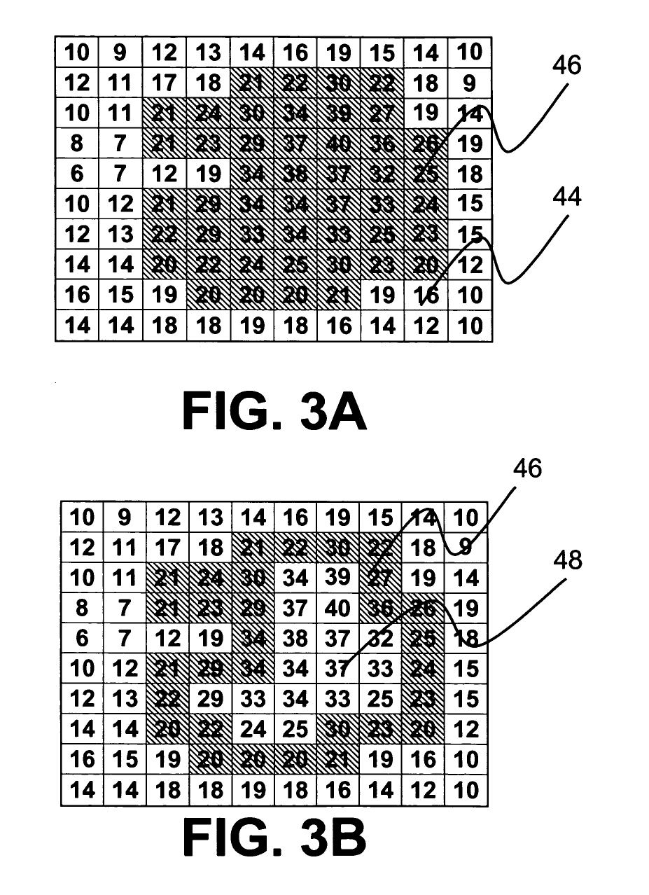

FIG. 3A illustrates the application of a threshold to the data as indicated by step 22. In the present illustration, the threshold that is applied is the numerical value twenty. The portion of data which exceed the threshold value of 20 is identified by grey shaded region 46. The portion of data which does not exceed the threshold value of 20 is identified by non-shaded region 44.

Although many possible sets of metrics may be computed by applying threshold to the data, several particularly useful metrics will be described herein. One possible metric is “percentage of pixels which exceed the threshold.” Percentage of pixels which exceed the threshold may be computed by multiplying 100 times the quotient of the number of pixels which exceed the threshold divided by the total number of pixels. In the example, shown in FIG. 3A, the percentage of pixels which exceed the threshold is 47% (100×(47/100)).

Another possible metric includes the “average value of pixels which exceed the threshold.” The average value of pixels which exceed the threshold for the example shown in FIG. 3A is 27.7 (average of (21, 22, 30, 22, 21, 24 . . . )). Yet another possible metric may include the “standard deviation of pixels that are above the threshold.” The standard deviation of pixels that are above the threshold for the example shown in FIG. 3A is 6.3 (standard deviation of (21, 22, 30, 22, 21, 24 . . . )).

Other metrics may incorporate the concept of core pixels. “Core pixels” may be defined as pixels that exceed the threshold that are also surrounded by pixels that exceed the threshold. The concept of core pixels is illustrated in FIG. 3B. Core pixels are identified by non-shaded region 48 that is contained within shaded region 46. Many of the aforementioned metrics used for pixels which exceed the threshold may also be used for core pixels, including the total percentage of core pixels. In the example illustrated in FIG. 3B, the total percentage of core pixels would be 17% (100×(17/100)). Another metric may be computed for the percentage of pixels which exceed the threshold which are also core pixels. In the example illustrated in FIG. 3B, the percentage of pixels which exceed the threshold which are also core pixels would be 36% (100×(17/47)).

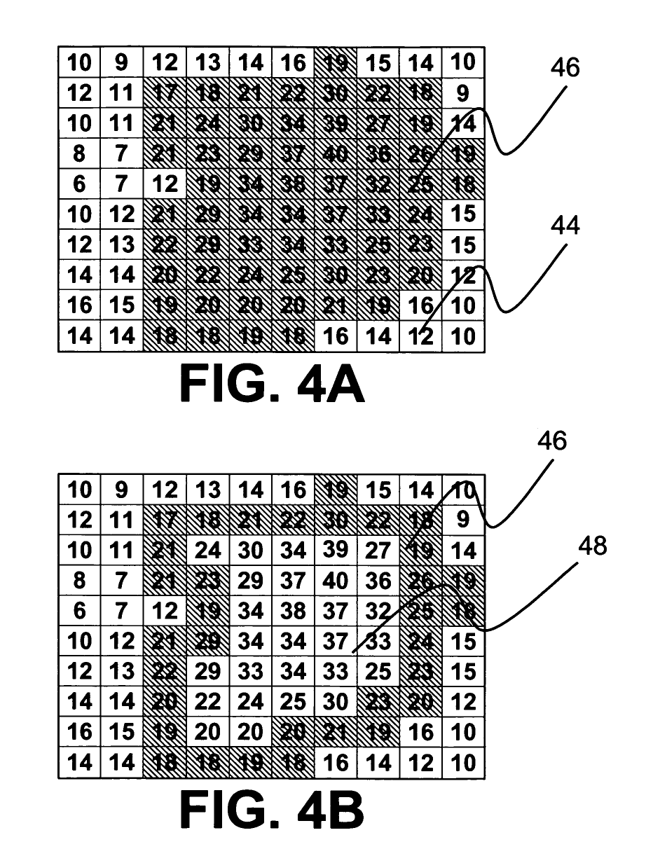

A second set of metrics is then computed for a different threshold as illustrated by the example in FIGS. 4A and 4B. In FIG. 4A a threshold of 17 is applied to the same array of pixels. As before, the portion of data which exceed the threshold value of 17 is identified by grey shaded region 46. The portion of data which does not exceed the threshold value of 17 is identified by non-shaded region 44. FIG. 4B illustrates the core pixels of the array when a threshold of 17 is applied. Core pixels are identified in FIG. 4B as non-shaded region 48. The same metrics that were computed for the threshold of 20 are also computed for the threshold of 17.

In the preferred embodiment, a set of metrics is computed for all reasonable thresholds. In the current examples, sets of metrics may be computed for all threshold values between 7 (the lowest value in the array of pixels) and 40 (the highest value in the array of pixels). The set of metrics may include any number of metrics, including a single metric.

Each set of metrics is then correlated to the forest attributes measured from the ground, as indicated by step 24. Mathematical expressions are developed for each set of metrics, as indicated by step 26. A score is then computed for each mathematical expression which describes how accurately the mathematical expression relates the set of metrics to the ground measured data, as indicated by step 28. The scores are compared and the optimal mathematical expression is determined.

There are many known techniques for correlating sets of data to develop mathematical equations. Although any modeling technique may be used, the preferred embodiment of the present invention utilizes the following approach. Remotely sensed data is obtained for multiple plots. In the current example, canopy height models are produced from LiDAR data like the example illustrated in FIG. 2. Thresholds are applied to the canopy height models to determine metric values for each threshold and each plot of data as illustrated in the following tables.

TABLE 1 shows values for Metric 1 for each plot and thresholds of 7-10. In the current example, Metric 1 is the average pixel value of pixels which exceed the corresponding threshold. Accordingly, Metric 1 describes the average canopy height for pixels within the plot that exceed each threshold. For purposes of illustration, the thresholds for Metric 1 will hereinafter be referred to as t₁, wherein t₁(n) represents the set of Metric 1 values, m₁, for a threshold value of n.

TABLE 1

| | Metric | Metric | | | |
|---|---|---|---|---|---|
| Thresh- | 1 for | 1 for | Metric 1 for | Metric 1 for | Metric 1 for |
| old | Plot 1 | Plot 2 | Plot 3 | Plot 4 | Plot 5 |
| 7 | 13 | 16 | 23 | 14 | 9 |
| 8 | 14 | 17 | 24 | 15 | 12 |
| 9 | 15 | 19 | 24 | 16 | 14 |
| 10 | 18 | 20 | 25 | 16 | 15 |

TABLE 2 shows values for Metric 2 for each plot and thresholds of 7-10. In the current example, Metric 2 is the standard deviation of values of pixels exceeding the corresponding threshold. For purposes of illustration, the thresholds for Metric 2 will hereinafter be referred to as t₂, wherein t₂(n) represents the set of Metric 2 values, m₂, for a threshold value of n.

TABLE 2

| | Metric | Metric | | | |
|---|---|---|---|---|---|
| Thresh- | 2 for | 2 for | Metric 2 for | Metric 2 for | Metric 2 for |
| old | Plot 1 | Plot 2 | Plot 3 | Plot 4 | Plot 5 |
| 7 | 6.3 | 2.4 | 4.4 | 6.2 | 8.7 |
| 8 | 6.1 | 2.9 | 4.4 | 6.7 | 8.2 |
| 9 | 5.5 | 2.3 | 4.4 | 6.6 | 7.6 |
| 10 | 5.5 | 2.2 | 4.3 | 6.6 | 7.1 |

TABLE 3 shows ground measurements for a forest attribute of interest for each plot. In the current example, the forest attribute of interest is the basal area of each plot determined by a person taking measurements on the ground.

TABLE 3

| | Plot | | | | |
|---|---|---|---|---|---|
| | 1 | 2 | 3 | 4 | 5 |
| Basal | 70 | 90 | 130 | 70 | 40 |
| Area | | | | | |

Mathematical equations are then computed for every combination of t₁ and t₂, relating the corresponding values of m₁ and m₂ to the forest attribute of interest. The ground measured forest attribute of interest is modeled as a dependent variable which is a function of m₁ and m₂. A score is computed for each equation. In the current example, the score is the R-squared value, or coefficient of determination, for each equation.

The “best fit” equation for the combination of t₁(7) and t₂(7) is BA=−3.126+6.015(m₁)−1.269(m₂), where BA is the basal area for the plot for which values of m₁ and m₂ are taken. The R-squared value for this equation is 0.996. For the combination of t₁(7) and t₂(8), the best fit equation is BA=0.843+5.927(m₁)−1.723(m₂), having a R-squared value of 0.997. For the combination of t₁(7) and t₂(9), the best fit equation is BA=−1.811+6.023(m₁)−1.617(m₂), having a R-squared value of 0.998. The reader will note that if best-fit equations were used for all combinations of t₁(n) and t₂(n) from n=7 to n=40, 1156 different equations would be evaluated.

Although FIG. 1 illustrates the application of threshold to the remotely sensed data as an iterative method, in which different thresholds are successively applied to remotely sensed data after determination 30 is made as to whether to apply a new threshold (as indicated by step 32), the different thresholds may also be applied to the data virtually simultaneously. For example, an upper extreme value and lower extreme value may be first determined for all domain values of remotely sensed data 18. All thresholds between the lower extreme value and the upper extreme value may then be applied to the data as separate operations to produce corresponding sets of metrics for each threshold. Simultaneous determination of best-fit equations and scores may then be conducted. The best-fit equation having the best score may then be selected as the optimal mathematical expression.

The optimal mathematical expressions and corresponding optimal thresholds are then used to estimate forest attributes of interest for the remainder of the forest stand, as indicated by step 34. In order to estimate forest attributes for other portions of a forest stand, remotely sensed data for other portions of a forest stand is first obtained. The remotely sensed data is again preprocessed to produce a grid of values corresponding to the remotely sensed data. The optimal threshold values are applied to the grid of values to compute sets of metrics. The sets of metrics may then be inserted into the optimal equations to compute an estimate of a particular forest parameter of interest.

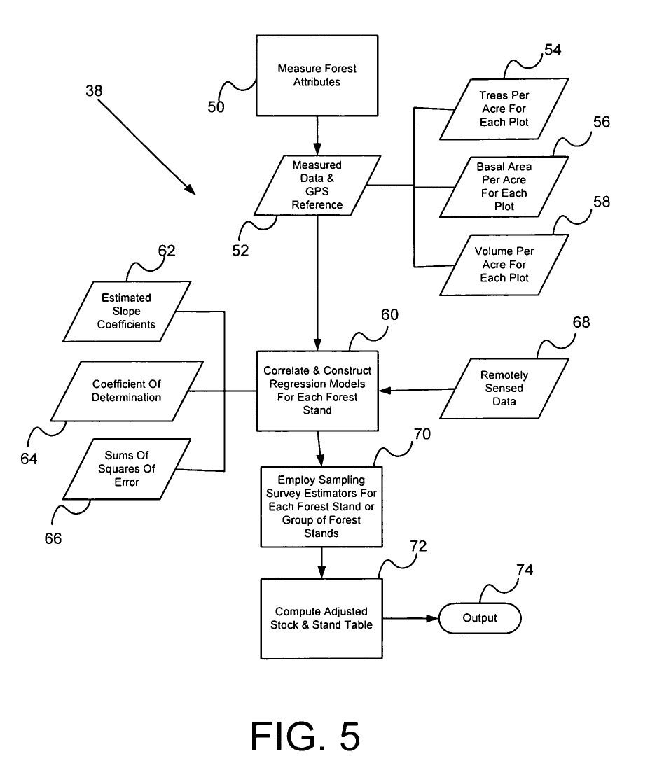

As described above, the optimal equation may be used to predict attributes of interest for other portions of the forest stand for which remotely sensed data is available, as indicated by step 36. Post processing 38 may also be used to convert the data into a form that is more useful to the end user, including mean volume per acre and standard error for each forest stand. As illustrated in FIG. 5, Post processing 38 accomplishes this by matching forest attribute estimates from the image processing component to ground measurements obtained from field samples.

As indicated by step 50, the user first measures forest attributes. Measured data 52 is collected for each field plot for the attributes of trees per acre (as indicated by measured data 54), basal area per acre (as indicated by measured data 56), and volume per acre (as indicated by measured data 58) along with GPS references for the plot. In the preferred embodiment, measured data 52 is input to a computer program so that it may be later used to construct regression models for each forest stand. The units for volume may be provided in cubic volume or weight with Imperial or Metric scale. TABLE 4A shows an example of measured data 52.

TABLE 4A
Original Observed Stand Table

| Diameter (in.) | | Measured | Measured | Measured |
|---|---|---|---|---|
| & Species | Product | tpa (Tio) | BA/ac | Vol/ac (Vic) |
| 7 Pine | pulp | 19 | 5.08 | 166.06 |
| 8 Pine | pulp | 31 | 10.82 | 407.03 |
| 9 Pine | pulp | 42 | 18.55 | 766.08 |
| 10 Pine | pulp | 20 | 10.91 | 482.2 |
| 10 Pine | chip & saw | 25 | 13.64 | 602.75 |
| 11 Pine | chip & saw | 38 | 25.08 | 1179.14 |
| 12 Pine | sawtimber | 24 | 18.85 | 928.08 |
| 13 Pine | sawtimber | 7 | 6.45 | 331.8 |
| 13 Hardwood | pulp | 3 | 2.77 | 142.2 |
| 14 Pine | sawtimber | 3 | 3.21 | 170.01 |
| | Total | 212 | 115.35 | 5175.35 |

As indicated by step 60, the computer program is then used to correlate remotely sensed data 68 with the measured data 52, and regression analyses are performed for each forest stand. Ground plot data, or measured data 52, is treated as a dependent variable that is a function of remotely sensed data 68 for the purposes of these analyses. Regression models are constructed to predict trees per acre, basal area per acre, and volume per acre using the previously described threshold optimization method. For each stand, the user obtains estimated slope coefficients (as indicated by model data 62), the coefficient of determination (as indicated by model data 64), and the sums of squares of error computed with the jackknife deviance residuals (as indicated by model data 66). Jackknife deviance residuals may be computed using the R statistical package R (created by R Development Core Team).

The jackknife deviance residual (“jdr”) equals the quotient of the raw residual of the i^{th} observation and the square root of 1 minus the ith diagonal term of the Hat (H) matrix:

$$jdr = \frac{{e}_{i}}{\sqrt{1 - {h}_{ii}}}$$

where hᵢᵢ is the i^{th} diagonal element of the Hat matrix.
For simple linear regression, jdr is described by the following equation:

$$jdr = \frac{{e}_{i}}{\sqrt{1 - ( \frac{1}{n} + \frac{{( {x}_{i} - \overline{x} )}^{2}}{\sum {( {x}_{i} - \overline{x} )}^{2}} )}}$$

The Hat matrix transforms the dependent variable y into predicted values of the dependent variable ŷ, where ŷ=Hy. The residual eᵢ=yᵢ−ŷᵢ. yᵢ is the generalized expression used to represent volume per acre, basal area per acre, or trees per acre measured on the ground, while xᵢ is generalized as the metric values obtained from remotely sensed data that are matched in location to the ground plots.

Using the regression models, sampling survey estimators are employed (as indicated by step 70) that use data collected from the remotely sensed image for each forest stand. For stands with a sample size exceeding 9 plots, the attribute of interest [volume per acre (V), basal area per acre (B), or trees per acre (N)] is estimated with

ŷ_{V.lr}= y̅_{V}+b_{1V}( M̅₁− m̅₁)+b_{2V}( M̅₂− m̅₂)

ŷ_{B.lr}= y̅_{B}+b_{1B}( M̅₁− m̅₁)+b_{2B}( M̅₂− m̅₂)

ŷ_{N.lr}= y̅_{N}+b_{1N}( M̅₁− m̅₁)+b_{2N}( M̅₂− m̅₂)

where m₁ and m₂ are metrics obtained from remotely sensed data superimposed on ground plots, M₁ and M₂ are metrics obtained from the remotely sensed data for the entire stand, and bᵢ are slope coefficients.

Variance is estimated with

$$V ( {\overline{y}}_{lr} ) = \frac{( 1 - f )}{n} {S}_{y}^{2} ( 1 - {ρ}^{2} )$$

$$where$$

$${ρ}^{2} = 1 - \frac{\sum jdr}{\sum {( y - \overline{y} )}^{2}} ;$$

### S_{y} is population standard deviation; and f, the finite population correction is assumed to equal zero.

Small forest stands (or stands with 9 or fewer plots) are grouped with other stands of similar age, species, site quality, and silvicultural history for stratified sampling however with the use of combined slope coefficients. The general form of the combined regression estimator for stratified sampling is the following equations are used to

y̅_{lrhc}= y̅ₕ+b_{c}( X̅ₕ− x̅ₕ)
where y̅ₕ=mean value of volume per acre, basal area per acre, or trees per acre for stratum h measured from the ground plots.
   b_{c}=combined slope estimate for all strata.
X̅ₕ=mean value of metric Mᵢ obtained from remotely sensed data for the entire stratum h
x̅ₕ=mean value of metric mᵢ obtained from remotely sensed data superimposed on the ground plots in stratum h.

The variance of all stratum is defined as

$$V ( {\overline{y}}_{lrs} ) = {\sum }_{h} \frac{{W}_{h}^{2} ( 1 - {f}_{h} )}{{n}_{h}} {S}_{yh}^{2} ( 1 - {ρ}_{c}^{2} )$$

where once again the jackknife deviance residuals are used to estimate the ρ statistic.

The reader will note that while a combined b_{c} slope estimate and ρ_{c} estimate are used for all stands grouped together, the estimates of volume per acre, basal area per acre, and tree per acre for each stand requires individual stand records for y̅ₕ, X̅ₕ, and x̅ₕ.

A more thorough discussion of sampling survey estimators is available in Chapter 7 of Cochran. W. G. 1977. Sampling Techniques. 3^{rd} Ed. John Wiley & Sons. New York.

As indicated by step 72, an adjusted stand and stock table is then computed using the estimated values of volume per acre, basal area per acre, and trees per acre using regression estimators determined in step 70. In the preferred embodiment, the adjusted stand and stock table contain trees per acre and volume per acre by 1-inch diameter classes. The preferred adjusted stand and stock table also includes species group and product. The adjusted stand and stock table is based on an extension of the constrained minimization approach with LaGrangian multipliers as explained in Matney, T. G. and R. C. Parker. 1991. For. Sci. 37(6):1605-1613.

Using Lagrangian multipliers, the adjusted numbers of trees (Tᵢₐ) for the ith diameter class that minimizes

$${\sum }_{i = 1}^{M} {W}_{i} \{ {[ ( {B}_{ic} - {T}_{ia} {b}_{i} ) / {\overline{y}}_{B} ]}^{2} + {[ ( {V}_{ic} - {T}_{ia} {v}_{i} ) / {\overline{y}}_{V} ]}^{2} + {[ ( {T}_{ic} - {T}_{ia} ) / {\overline{y}}_{N} ]}^{2} \}$$

Tᵢₐ=Tᵢₒ+λbᵢ/(WᵢXᵢ)+δvᵢ/(WᵢXᵢ)+γ/(WᵢXᵢ)

where Tᵢₐ is the adjusted number of trees per acre in ith diameter class, bᵢ is the mean basal area of trees in the ith diameter class, vᵢ is the mean tree volume for trees in the ith diameter class, Tᵢₐbᵢ is the adjusted basal area per acre in the ith diameter class, Tᵢₐvᵢ is the adjusted volume per acre in the ith diameter class, B_{ic} is the observed basal area per acre in the ith diameter class, V_{ic} is the observed volume per acre in the ith diameter class, T_{ic} is the observed number of trees per acre in the ith diameter class, y̅_{B} is the average basal area per acre from the ground plots, y̅_{V} is the average volume per acre from the ground plots, y̅_{N} is the average trees per acre from the ground plots, M is the number of diameter classes, Wᵢ is the weight assigned to the ith diameter class, and Xᵢ is defined as:

$${X}_{i} = \frac{{b}_{i}^{2}}{{\overline{y}}_{B}^{2}} + \frac{{v}_{i}^{2}}{{\overline{y}}_{V}^{2}} + \frac{1}{{\overline{y}}_{N}^{2}}$$

### The unknowns λ, δ, and γ, may be determined by solving the following simultaneous system of equations

$$[ \begin{matrix}λ \\ δ \\ γ\end{matrix} ] = {[ \begin{matrix}{R}_{bb} & {R}_{bv} & {R}_{b} \\ {R}_{bv} & {R}_{vv} & {R}_{v} \\ {R}_{b} & {R}_{v} & {R}_{1}\end{matrix} ]}^{- 1} [ \begin{matrix}{\hat{y}}_{B . lr} - {\overline{y}}_{B} \\ {\hat{y}}_{V . lr} - {\overline{y}}_{V} \\ {\hat{y}}_{N . lr} - {\overline{y}}_{N}\end{matrix} ]$$

$$where$$

$${R}_{bb} = {\sum }_{i = 1}^{M} \frac{{b}_{i}^{2}}{{W}_{i} {X}_{i}} , \\ {R}_{bv} = {\sum }_{i = 1}^{M} \frac{{b}_{i} {v}_{i}}{{W}_{i} {X}_{i}} , \\ {R}_{b} = {\sum }_{i = 1}^{M} \frac{{b}_{i}}{{W}_{i} {X}_{i}} , \\ {R}_{vv} = {\sum }_{i = 1}^{M} \frac{{v}_{i}^{2}}{{W}_{i} {X}_{i}} , \\ {R}_{v} = {\sum }_{i = 1}^{M} \frac{{v}_{i}}{{W}_{i} {X}_{i}} , and$$

$${R}_{1} = {\sum }_{i = 1}^{M} \frac{1}{{W}_{i} {X}_{i}} .$$

In addition to the constraints imposed by Matney and Parker (Matney, T. G. and R. C. Parker. 1991. For. Sci. 37(6):1605-1613), the preferred process also constrains the sum of trees per acre by diameter class to equal the stand level of trees per acre obtained in step 60 and step 70.

The proposed “adjustment procedure” used in the preferred process requires the user to furnish an initial observed stand and stock table (described in Matney and Parker with the variables Tᵢₒ and V_{ic}). These variables are also collected in step 50.

An adjusted stand and stock table produced using the present invention is illustrated in TABLE 4B. The values for ŷ_{V.lr}, ŷ_{B.lr}, an dŷ_{N.lr} are computed in steps 60 and 70 as estimated volume per acre for the entire stand, estimated basal area per acre for the entire stand, and estimated trees per acre for the entire stand, respectively. From step 70, the estimated volume per acre for the forest stand was computed to be 4300 ft³/acre. The estimated basal area per acre was computed to be 95 ft²/acre, and the estimated number of tree per acre was computed to be 175. The original stand and stock table, depicted in TABLE 4A, is adjusted as described previously to produce TABLE 4B, and is consistent with the predicted stand level attributes computed in Step 70.

TABLE 4B
Adjusted Stand Table

| Diameter (in.) | | Measured | Measured | Measured |
|---|---|---|---|---|
| & Species | Product | tpa (Tio) | BA/ac | Vol/ac (Vic) |
| 7 Pine | pulp | 53.2 | 14.21 | 464.84 |
| 8 Pine | pulp | 10.1 | 3.54 | 133.18 |
| 9 Pine | pulp | 18.5 | 8.17 | 337.35 |
| 10 Pine | pulp | 4.9 | 2.69 | 118.72 |
| 10 Pine | chip & saw | 9.9 | 5.41 | 239.27 |
| 11 Pine | chip & saw | 33.6 | 22.19 | 1043.36 |
| 12 Pine | sawtimber | 23.9 | 18.76 | 923.64 |
| 13 Pine | sawtimber | 9.6 | 8.81 | 453.08 |
| 13 Hardwood | pulp | 5.6 | 5.12 | 263.48 |
| 14 Pine | sawtimber | 5.7 | 6.09 | 323.08 |
| | Total | 175 | 95 | 4300 |

The reader will note that the constrained minimization procedure may result in the illogical assignment of negative adjusted trees per acre to a given diameter class. If this occurs, a simpler constrained minimization procedure is invoked that constrains only the sum of volume per acre by diameter class to equal the stand level of volume per acre determined in step 70.

As shown in TABLE 4B, output 74 is a stand and stock table showing volume per acre, basal area per acre, trees per acre by 1-inch classes for each species and product. Output 74 may be in the form of electronic and/or hard-copy files. In the preferred embodiment, standard errors are reported for volume per acre, basal area per acre, and trees per acre.

The preceding description contains significant detail regarding the novel aspects of the present invention. It should not be construed, however, as limiting the scope of the invention but rather as providing illustrations of the preferred embodiments of the invention. As an example, the mathematical expressions derived in step 26 may assume many different forms or have any number of independent variables. Thus, the scope of the invention should be fixed by the following claims, rather than by the examples given.

1. A method for estimating physical characteristics of a forest comprising the steps of:
a. establishing a first ground plot having a first geographic location within said forest;
b. measuring a first set attributes of a portion of said forest within said first ground plot;
c. obtaining remotely sensed data for said first ground plot, said remotely sensed data describing features of said first ground plot observable from a remote distance;
d. processing said remotely sensed data for said first ground plot, wherein during said processing, a plurality of thresholds are applied to said remotely sensed data to derive a plurality of sets of metrics for said first ground plot, each of said plurality of metrics corresponding to one of said plurality of thresholds;
e. correlating said plurality of sets of metrics with said first set of attributes and developing an optimal mathematical expression which accurately predicts said first set of attributes as a function of at least one metric obtained from said remotely sensed data;
f. using said optimal mathematical expression to predict the physical characteristics of said forest outside of said first ground plot.

2. The method of claim 1, wherein each of said plurality of threshold separates said remotely sensed data into a first portion having values which exceed said first threshold and a second portion having values which do not exceed said first threshold.

3. The method of claim 2, wherein said first portion of said remotely sensed data is utilized to determine said plurality of sets of metrics.

4. The method of claim 1, said optimal mathematical expression is determined by:
a. computing a plurality of mathematical expressions correlating said plurality of sets of metrics with said forest attributes measured in step b of claim 1; and
b. computing a score for each of said plurality of mathematical expressions.

5. The method of claim 1, wherein each of said plurality of sets of metrics includes a metric selected from the group consisting of:
a. the percentage of pixels exceeding said threshold;
b. the average value of pixels exceeding said threshold;
c. the standard deviation of pixels exceeding said threshold;
d. the total percentage of core pixels;
e. the percentage of pixels exceeding said threshold which are also core pixels;
f. the average value of core pixels; and
g. the standard deviation of core pixels.

6. The method of claim 1, further comprising the step of computing an adjusted stand and stock table for said forest, said adjusted stand and stock table describing said inventory of said forest.

7. The method of claim 6, wherein said adjusted stand and stock table comprises a computed value of volume per acre.

8. The method of claim 6, wherein said adjusted stand and stock table comprises a computed value of the quantity of trees per acre.

9. The method of claim 6, wherein said adjusted stand and stock table comprises a computed value of basal area per acre.

10. The method of claim 6, wherein said adjusted stand and stock table comprises computed values for volume per acre for each 1-inch diameter class and by product and species group.

11. The method of claim 1, wherein each of said plurality of sets of metrics is derived by:
a. rasterizing said remotely sensed data as an array of pixels on a grid; and
b. separating said array of pixels into a first portion and a second portion, said first portion having values exceeding said associated threshold, and said second portion having values not exceeding said associated threshold.

12. The method of claim 11, wherein each of said plurality of sets of metrics includes a metric selected from the group consisting of:
a. the percentage of pixels exceeding said threshold, computed by dividing the number of pixels in said first portion by the total number of pixels in said array of pixels;
b. the average value of pixels exceeding said threshold, computed by averaging the values of pixels in said first portion;
c. the standard deviation of pixels exceeding said threshold, determined by calculating the standard deviation of the values of pixels in said first portion;
d. the total percentage of core pixels, determined by separating said first portion into a first subset portion and a second subset portion, said first subset portion including only pixels which are surrounded on all sides by other pixels that are in said first portion, and said second subset portion including only pixels which are not surrounded on all sides by other pixels that are in said first portion, and dividing the quantity of pixels in said first subset portion by the total number of pixels in said array of pixels;
e. the percentage of pixels exceeding said threshold which are also core pixels, computed by dividing the total quantity of pixels in said first subset portion by the total quantity of pixels in said first portion;
f. the average value of core pixels, computed by averaging the values of pixels in said first subset portion; and
g. the standard deviation of core pixels, determined by calculating the standard deviation of the values of pixels in said first subset portion.

13. A method for estimating physical characteristics of a forest comprising the steps of:
a. establishing a first ground plot having a first geographic location within said forest;
b. measuring a first set of attributes of a portion of said forest within said first ground plot;
c. obtaining remotely sensed data for said first ground plot, said remotely sensed data describing features of said first ground plot observable from a remote distance;
d. processing said remotely sensed data for said first ground plot, wherein during said processing, a first threshold is applied to said remotely sensed data to derive a first set of metrics for said first ground plot, said first set of metrics describing said remotely sensed data;
e. correlating said first set of metrics with said first set of attributes and developing a first mathematical expression which accurately predicts said first set of attributes as a function of said first set of metrics obtained from said remotely sensed data;
f. processing said remotely sensed data for said first ground plot a second time, wherein during said processing, a second threshold is applied to said remotely sensed data to derive a second set of metrics for said first ground plot, said second set of metrics describing said remotely sensed data;
g. correlating said second set of metrics with said first set of attributes and developing a second mathematical expression which accurately predicts said first set of attributes as a function of said second set of metrics; and
h. determining an optimal mathematical expression for estimating forest inventory between said first mathematical expression and said second mathematical expression;
i. using said optimal mathematical expression to estimate inventory of said forest outside of said first ground plot.

14. The method of claim 13, wherein said first threshold separates said remotely sensed data into a first portion having values which exceed said first threshold and a second portion having values which do not exceed said first threshold.

15. The method of claim 14, wherein said first portion of said remotely sensed data is converted to said first set of metrics.

16. The method of claim 13, said optimal mathematical expression is determined by:
a. computing a score for said first mathematical expression, said score describing how accurately said first mathematical expression relates said forest attributed measured in step b of claim 1 with said first portion of remotely sensed data; and
b. computing a second score for said second mathematical expression, said second score describing how accurately said second mathematical expression relates said forest attributed measured in step b of claim 1 with said third portion of remotely sensed data.

17. The method of claim 13, wherein said first set of metrics includes a metric selected from the group consisting of:
a. the percentage of pixels exceeding said threshold;
b. the average value of pixels exceeding said threshold;
c. the standard deviation of pixels exceeding said threshold;
d. the total percentage of core pixels;
e. the percentage of pixels exceeding said threshold which are also core pixels;
f. the average value of core pixels; and
g. the standard deviation of core pixels.

18. The method of claim 13, further comprising the step of computing an adjusted stand and stock table for said forest, said adjusted stand and stock table describing said inventory of said forest.

19. The method of claim 18, wherein said adjusted stand and stock table comprises computed values for volume per acre for each 1-inch diameter species class and product.

20. The method of claim 13, wherein each of said first set of metrics is derived by:
a. rasterizing said remotely sensed data as an array of pixels on a grid; and
b. separating said array of pixels into a first portion and a second portion, said first portion having values exceeding said first threshold, and said second portion having values not exceeding said first threshold.
